(19) United States
(12) Patent Application Publication
(10) Pub. No.: US 2022/0358675 A1
(43) Pub. Date: Nov. 10, 2022

(54) METHOD FOR TRAINING MODEL, METHOD FOR PROCESSING VIDEO, DEVICE AND STORAGE MEDIUM

(71) Applicant: Beijing Baidu Netcom Science Technology Co., Ltd., Beijing (CN)

(72) Inventors: Guanying CHEN, Beijing (CN); Xiaoqing YE, Beijing (CN); Xiao TAN, Beijing (CN); Hao SUN, Beijing (CN)

(21) Appl. No.: 17/869,161

(22) Filed: Jul. 20, 2022

(30) Foreign Application Priority Data
Aug. 25, 2021 (CN) 202110983376.9

(51) Int. Cl. G06T 7/73; G06T 7/13; G06T 7/174

(52) U.S. Cl. CPC G06T 7/75; G06T 7/13; G06T 7/174; G06T 2207/20081

(57) ABSTRACT

A method and apparatus for training a model, a method and apparatus for processing a video, a device and a storage medium are provided. An implementation of the method for training a model includes: analyzing a sample video, to determine a plurality of human body image frames in the sample video; determining human body-related parameters and camera-related parameters corresponding to each human body image frame; determining, based on the human body-related parameters, the camera-related parameters and an initial model, predicted image parameters of an image plane corresponding to the each human body image frame, the camera-related parameters and image parameters; and training the initial model based on original image parameters of the human body image frames in the sample video and the predicted image parameters of image planes corresponding to the human body image frames, to obtain a target model.

### CROSS-REFERENCE TO RELATED APPLICATIONS

This application claims priority to Chinese Patent Application No. 202110983376.9, filed with the China National Intellectual Property Administration (CNIPA) on Aug. 25, 2021, the content of which is incorporated herein by reference in its entirety.

### TECHNICAL FIELD

The present disclosure relates to the field of artificial intelligence, in particular to computer vision and deep learning technologies, and more particular to a method and apparatus for training a model, a method and apparatus for processing a video, a device and a storage medium, which may be used in virtual human and augmented reality scenarios in particular.

### BACKGROUND

With the widespread popularization of computers, digital cameras and digital video cameras, people's demand for audio-visual entertainment production is getting higher and higher. What followed was the boom in the field of home digital entertainment, and more and more people began to try to be amateur “directors”, keen to produce and edit various ordinary realistic videos. A video processing solution from another perspective to enrich the diversity of video processing is demanded.

### SUMMARY

Embodiments of the present disclosure provides a method for training a model, a method for processing a video, a device and a storage medium.

In a first aspect, some embodiments of the present disclose provide a method for training a model, the method includes: analyzing a sample video, to determine a plurality of human body image frames in the sample video; determining human body-related parameters and camera-related parameters corresponding to each human body image frame; determining, based on the human body-related parameters, the camera-related parameters and an initial model, predicted image parameters of an image plane corresponding to the each human body image frame, the initial model being used to represent a corresponding relationship between the human body-related parameters, the camera-related parameters and image parameters; training the initial model based on original image parameters of the human body image frames in the sample video and the predicted image parameters of image planes corresponding to the human body image frames, to obtain a target model.

In a second aspect, some embodiments of the present disclosure provide a method for processing a video, the method includes: acquiring a target video and an input parameter; and determining a processing result of the target video, based on video frames in the target video, the input parameter, and the target model trained and obtained by the method according to the first aspect.

In a third aspect, some embodiments of the present disclosure provide an electronic device, the electronic device includes: at least one processor; and a memory communicatively connected to the at least one processor; where the memory stores instructions executable by the at least one processor, and the instructions, when executed by the at least one processor, cause the at least one processor to perform the method according to the first aspect or perform the method according to the second aspect.

In a fourth aspect, some embodiments of the present disclosure provide a non-transitory computer readable storage medium storing computer instructions, wherein, the computer instructions, when executed by a computer, cause the computer to perform the method according to the first aspect or perform the method according to the second aspect.

It should be understood that the content described in this section is not intended to identify key or important features of embodiments of the present disclosure, nor is it intended to limit the scope of the present disclosure. Other features of the present disclosure will become readily understood from the following specification.

### BRIEF DESCRIPTION OF THE DRAWINGS

The accompanying drawings are used for better understanding of the present solution, and do not constitute a limitation to scope of the present disclosure. In which:

FIG. 1 is an exemplary system architecture diagram to which an embodiment of the present disclosure may be applied;

FIG. 2 is a flowchart of a method for training a model according to an embodiment of the present disclosure;

FIG. 3 is a flowchart of a method for training a model according to another embodiment of the present disclosure;

FIG. 4 is a flowchart of yet a method for training a model according to another embodiment of the present disclosure;

FIG. 5 is a flowchart of a method for processing a video according to an embodiment of the present disclosure;

FIG. 6 is a schematic diagram of an application scenario of the method for training a model and the method for processing a video according to an embodiment of the present disclosure;

FIG. 7 is a schematic structural diagram of an apparatus for training a model according to an embodiment of the present disclosure;

FIG. 8 is a schematic structural diagram of an apparatus for processing a video according to an embodiment of the present disclosure; and

FIG. 9 is a block diagram of an electronic device for implementing the method for training a model and the method for processing a video according to embodiments of the present disclosure.

### DETAILED DESCRIPTION OF EMBODIMENTS

Example embodiments of the present disclosure are described below with reference to the accompanying drawings, where various details of embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

It should be noted that embodiments in the present disclosure and the features in the embodiments may be combined with each other on a non-conflict basis. Embodiments of the present disclosure will be described below in detail with reference to the accompanying drawings.

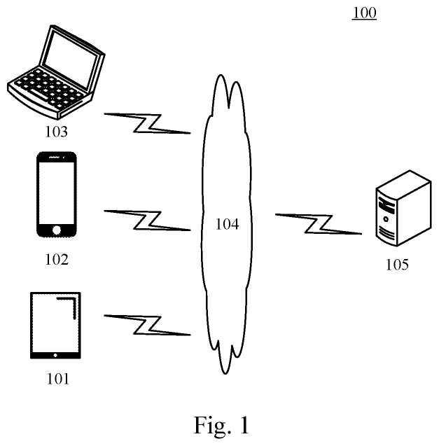

FIG. 1 illustrates an exemplary system architecture 100 to which embodiments of a method for training a model, a method for processing a video or an apparatus for training a model, an apparatus for processing a video may be applied.

As shown in FIG. 1, the system architecture 100 may include terminal device(s) 101, 102, 103, a network 104 and a server 105. The network 104 serves as a medium for providing a communication link between the terminal device(s) 101, 102, 103 and the server 105. The network 104 may include various types of connections, such as wired or wireless communication links, or optical fiber cables.

A user may use the terminal device(s) 101, 102, 103 to interact with the server 105 through the network 104 to receive or send messages and the like. Various communication client applications may be installed on the terminal device(s) 101, 102 and 103, such as video playback applications, or video processing applications.

The terminal device(s) 101, 102, and 103 may be hardware or software. When the terminal device(s) 101, 102, 103 are hardware, they may be various electronic devices, including but not limited to smart phones, tablet computers, vehicle-mounted computers, laptop computers, desktop computers, and so on. When the terminal device(s) 101, 102, 103 are software, they may be installed in the electronic devices listed above. They may be implemented as a plurality of software or software modules (for example, for providing distributed services), or as a single software or software module, which is not limited herein.

The server 105 may be a server that provides various services, for example, a backend server that provides models on the terminal device(s) 101, 102, 103. The backend server may use a sample video to train an initial model, to obtain a target model, and feed back the target model to the terminal device(s) 101, 102, 103.

It should be noted that the server 105 may be hardware or software. When the server 105 is hardware, it may be implemented as a distributed server cluster composed of a plurality of servers, or may be implemented as a single server. When the server 105 is software, it may be implemented as a plurality of software or software modules (for example, for providing distributed services), or may be implemented as a single software or software module, which is not limited herein.

It should be noted that the method for training a model provided by embodiments of the present disclosure is generally executed by the server 105, and the method for processing a video may be executed by the terminal device(s) 101, 102, 103, and may also be executed by the server 105. Correspondingly, the apparatus for training a model is generally provided in the server 105, and the apparatus for processing a video may be provided in the terminal device(s) 101, 102, 103, or may also be provided in the server 105.

It should be appreciated that the number of terminal devices, networks and servers in FIG. 1 is merely illustrative. Any number of terminal devices, networks and servers may be provided depending on the implementation needs.

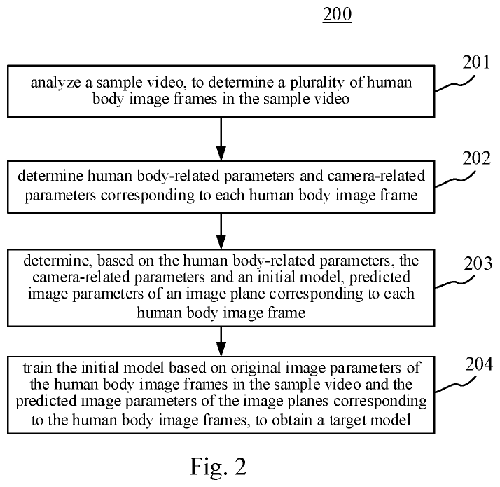

With further reference to FIG. 2, illustrating a flow 200 of a method for training a model according to an embodiment of the present disclosure. The method for training a model of the present embodiment includes the following steps:

Step 201, analyzing a sample video, to determine a plurality of human body image frames in the sample video.

In the present embodiment, an executing body (for example, the server 105 shown in FIG. 1) of the method for training a model may first acquire a sample video. The sample video may include a plurality of video frames, and each video frame may include an image of a human body. The executing body may analyze the sample video, for example, perform human body segmentation on the video frames in the sample video to obtain human body image frames. Sizes of the human body image frames may be the identical, and motion states of the human body in the human body image frames may be different.

Step 202, determining human body-related parameters and camera-related parameters corresponding to each human body image frame.

The executing body may further process the human body image frames, for example, input each of the human body image frames into a pre-trained model to obtain the human body-related parameters and the camera-related parameters. Here, the human body-related parameters may include a human body pose parameter, a human body shape parameter, a human body rotation parameter, and a human body translation parameter. Here, the pose parameter is used to describe pose of the human body, the shape parameter is used to describe the height, shortness, fatness and thinness of the human body, and the rotation parameter and the translation parameter are used to describe a transformation relationship between a human body coordinate system and a camera coordinate system. The camera-related parameters may include parameters such as camera intrinsic parameter and camera extrinsic parameter.

Alternatively, the executing body may perform various analyses (e.g., calibration) on each human body image frame to determine the above human body-related parameters and the camera-related parameters.

In the present embodiment, the executing body may sequentially process the human body-related parameters of each human body image frame in the sample video, and determine a pose of the camera in each human body image frame. According to a preset formula, the executing body may substitute the human body-related parameters of human body image frames into the above formula to obtain positions of the camera in the human body image frames. Alternatively, the executing body may first convert the human body image frames from the camera coordinate system to the human body coordinate system by using the rotation parameters and the translation parameters in the human body-related parameters. Then, relative positions of the camera to a center of the human body may be determined, thereby determining the poses of the camera in the human body coordinate system. Here, the center of the human body may be a hip bone position in the human body.

Step 203, determining, based on the human body-related parameters, the camera-related parameters and an initial model, predicted image parameters of image planes corresponding to the human body image frames.

The executing body may input the determined camera poses, human body-related parameters, and camera-related parameters into the initial model. The initial model is used to represent corresponding relationships between the human body-related parameters, the camera-related parameters and the image parameters. Output of the initial model is the predicted image parameters of an image plane corresponding to each human body image frame. Here, the image plane may be an image plane corresponding to the camera in a three-dimensional space. It may be understood that each human body image frame corresponds to a position of the camera, and in the three-dimensional space, each camera may also correspond to an image plane. Therefore, each human body image frame also has a corresponding relationship with an image plane. The predicted image parameters may include colors of pixels in a predicted human body image frame and densities of pixels in a predicted human body image frame. The above initial model may be a fully connected neural network.

Step 204, training the initial model based on original image parameters of the human body image frames in the sample video and the predicted image parameters of the image planes corresponding to the human body image frames, to obtain a target model.

After obtaining the predicted image parameters, the executing body may compare the original image parameters of the human body image frames in the sample video with the predicted image parameters of the image planes corresponding to the human body image frames, and parameters of the initial model may be adjusted based on differences between the two to obtain the target model.

Using the method for training a model provided by the above embodiment of the present disclosure, the target model for processing a video may be obtained by training, and the richness of video processing may be improved.

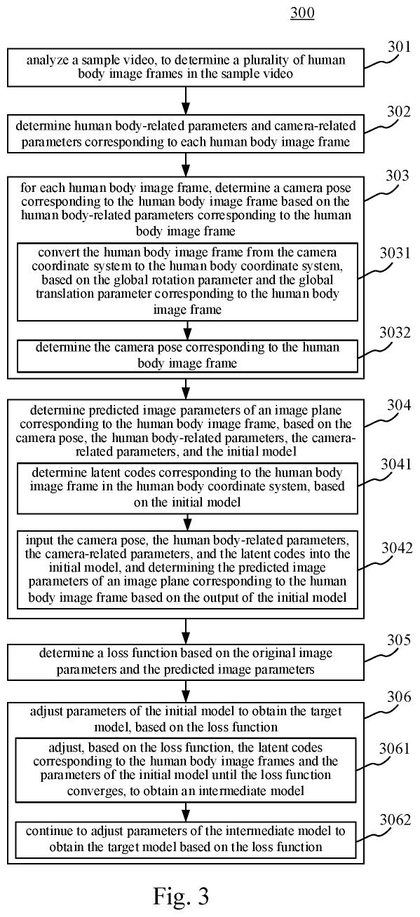

With further reference to FIG. 3, illustrating a flow 300 of a method for training a model according to another embodiment of the present disclosure. As shown in FIG. 3, the method of the present embodiment may include the following steps:

Step 301, analyzing a sample video, to determine a plurality of human body image frames in the sample video.

In the present embodiment, the executing body may sequentially input video frames in the sample video into a pre-trained human body segmentation network to determine the plurality of human body image frames in the sample video. Here, the human body segmentation network may be Mask R-CNN (Mask R-CNN is a network proposed in ICCV2017).

Step 302, determining human body-related parameters and camera-related parameters corresponding to each human body image frame.

In the present embodiment, the executing body may perform pose estimation on each of the human body image frames, and determine the human body-related parameters and the camera-related parameters corresponding to each human body image frame. The executing body may input each human body image frame into a pre-trained pose estimation algorithm for determination. The pose estimation algorithm may be vibe (video inference for human body pose and shape estimation).

Step 303, for each human body image frame, determining a camera pose corresponding to the human body image frame based on the human body-related parameters corresponding to the human body image frame.

In the present embodiment, the executing body may determine a camera pose corresponding to each human body image frame based on the human body-related parameters corresponding to each human body image frame. The human body-related parameters may include a global rotation parameter R of the human body and a global translation parameter T of the human body. The executing body may calculate the position of the camera through −Rₜ^{T}Tₜ, and calculate an orientation of the camera through Rₜ^{T}.

In some alternative implementations of the present embodiment, the above step 303 may determine the camera pose through the following operations:

Step 3031, converting the human body image frame from the camera coordinate system to the human body coordinate system, based on the global rotation parameter and the global translation parameter corresponding to the human body image frame.

Step 3032, determining the camera pose corresponding to the human body image frame.

In this implementation, the executing body may apply the global rotation parameter R of the human body and the global translation parameter T of the human body to the camera, and convert the human body image frame from the camera coordinate system to the human body coordinate system. It may be understood that the human body image frame belongs to a two-dimensional space, and after converted to the human body coordinate system, it is converted to the three-dimensional space. The three-dimensional space may include a plurality of spatial points, and these spatial points correspond to pixels in the human body image frame. Then, the executing body may further obtain the pose of the camera in the human body coordinate system corresponding to the human body image frame, that is, obtain the camera pose corresponding to the human body image frame.

Step 304, determining predicted image parameters of an image plane corresponding to the human body image frame, based on the camera pose, the human body-related parameters, the camera-related parameters, and the initial model.

In the present embodiment, the executing body may input the camera pose, the human body-related parameters, and the camera-related parameters into the above initial model, and use the output of the initial model as the predicted image parameters of the image plane corresponding to the human body image frame. Alternatively, the executing body may further process the output of the initial model to obtain the predicted image parameters.

In some alternative implementations of the present embodiment, the executing body may determine the predicted image parameters of a human body image frame through the following operations:

Step 3041, determining latent codes corresponding to the human body image frame in the human body coordinate system, based on the initial model.

Step 3042, inputting the camera pose, the human body-related parameters, the camera-related parameters, and the latent codes into the initial model, and determining the predicted image parameters of an image plane corresponding to the human body image frame based on the output of the initial model.

In this implementation, the executing body may first use the above initial model to initialize the human body image frame which has been converted into the human body coordinate system, to obtain the latent codes corresponding to the human body image frame. The latent codes may represent features of the human body image frame. Then, the executing body may input the camera pose, the human body-related parameters, the camera-related parameters, and the latent codes corresponding to the human body image frame into the initial model. The initial model described above may be a neural radiance field. The neural radiance field may implicitly learn static 3D scenarios using an MLP neural network. The executing body may determine the predicted image parameters of the human body image frame based on an output of the neural radiance field. In particular, the output of the neural radiance field is color and density information of 3D spatial points. The executing body may use the colors and the densities of the 3D spatial points to perform image rendering to obtain the predicted image parameters of the corresponding image plane. During rendering, the executing body may perform various processing (such as weighting, or integration) on the colors and the densities of the 3D spatial points to obtain the predicted image parameters.

Step 305, determining a loss function based on the original image parameters and the predicted image parameters.

After determining the predicted image parameters of the human body image frames, the executing body may determine the loss function in combination with the original image parameters of the human body image frames in the sample video. In particular, the executing body may determine the loss function based on differences between the original image parameters and the predicted image parameters. The loss function may be a cross-entropy loss function or the like. In some applications, the image parameters may include pixel values. The executing body may use a sum of squared errors of predicted pixel values and original pixel values as the loss function.

Step 306, adjusting parameters of the initial model to obtain the target model, based on the loss function.

The executing body may continuously adjust the parameters of the initial model based on the loss function, so that the loss function continues converging until a training termination condition is met, and then the adjustment of the initial model parameters is stopped to obtain the target model. The training termination condition may include, but is not limited to: the number of times of iteratively adjusting the parameters reaches a preset number threshold, and/or the loss function converges.

In some alternative implementation of the present embodiment, the executing body may adjust the parameters of the initial model through the following operations:

Step 3061, adjusting, based on the loss function, the latent codes corresponding to the human body image frames and the parameters of the initial model until the loss function converges, to obtain an intermediate model.

Step 3062, continuing to adjust parameters of the intermediate model to obtain the target model based on the loss function.

In this implementation, the executing body may first fix various parameters (such as pose parameter, shape parameter, global rotation parameter, global translation parameter, or camera internal parameter) of an input model, and adjust, based on the loss function, the latent codes corresponding to the human body image frames and the parameters of the initial model, until the loss function converges, to obtain the intermediate model. Then, the executing body may use latent codes and parameters of the intermediate model as initial parameters, and continue to adjust all the parameters of the intermediate model until the training is terminated to obtain the target model.

In some applications, the executing body may use an optimizer to adjust the parameters of the model. The optimizer may be L-BFGS (Limited-memory BFGS, one of the most commonly used algorithms for solving unconstrained nonlinear programming problems) or ADAM (an optimizer proposed in December 2014).

The method for training a model provided by the above embodiments of the present disclosure does not explicitly reconstruct the surface of the human body, but implicitly models the shape, texture, and pose information of the human body through the neural radiance field, so that a rendering effect of the target model on images is more refined.

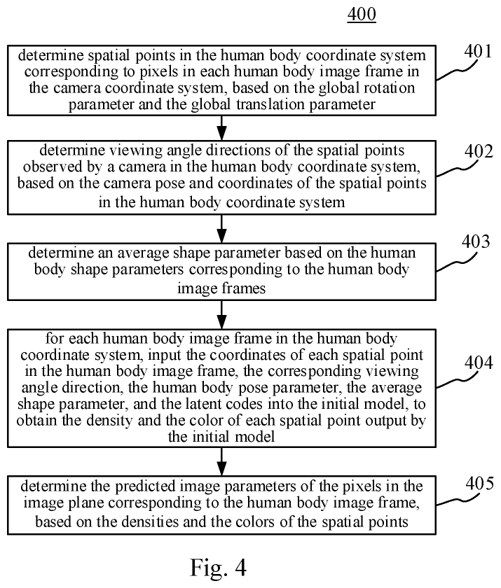

With further reference to FIG. 4, illustrating a flow 400 of determining predicted image parameters in the method for training a model according to an embodiment of the present disclosure. In the present embodiment, the human body-related parameters includes a human body pose parameter and a human body shape parameter, and the predicted image parameters may include a density and a color of a pixel. As shown in FIG. 4, the method of the present embodiment may determine the predicted image parameter through the following steps:

Step 401, determining spatial points in the human body coordinate system corresponding to pixels in each human body image frame in the camera coordinate system, based on the global rotation parameter and the global translation parameter.

In the present embodiment, when the executing body uses the global rotation parameter and the global translation parameter to convert a human body image frame in the sample video from the camera coordinate system to the human body coordinate system, it may also determine the spatial points of the human body image frame in the human body coordinate system corresponding to the pixels in the human body image frame, based on the global rotation parameter and the global translation parameter. It may be understood that the coordinates of a pixel are two-dimensional, and the coordinates of a spatial point are three-dimensional. Here, the coordinates of a spatial point may be represented by x.

Step 402, determining viewing angle directions of the spatial points observed by a camera in the human body coordinate system, based on the camera pose and coordinates of the spatial points in the human body coordinate system.

In the present embodiment, the camera pose may include the position and pose of the camera. The executing body may determine the viewing angle directions of the spatial points observed by the camera in the human body coordinate system, based on a position and pose of the camera and the coordinates of the spatial points in the human body coordinate system. In particular, the executing body may determine a line connecting a position of the camera and a position of a spatial point in the human body coordinate system; then, based on the pose of the camera, the viewing angle direction of the spatial point observed by the camera is determined. Here, d may be used to represent the viewing angle direction of a spatial point.

Step 403, determining an average shape parameter based on the human body shape parameters corresponding to the human body image frames.

In some applications, the sample video may be a video of human body motions, that is, the shapes of the human body in the video frames may be different. In the present embodiment, in order to ensure the stability of the human body shape during calculation, the executing body may average the human body shape parameters corresponding to the human body image frames to obtain the average shape parameter. Here, the average shape parameter may be represented by β. In this way, it is equivalent to forcing the human body shapes in the video frames to a fixed shape during the calculation, thereby improving the robustness of the model.

Step 404, for each human body image frame in the human body coordinate system, inputting the coordinates of each spatial point in the human body image frame, the corresponding viewing angle direction, the human body pose parameter, the average shape parameter, and the latent codes into the initial model, to obtain the density and the color of each spatial point output by the initial model.

In the present embodiment, for each human body image frame in the human body coordinate system, the executing body may input the coordinates x of the camera corresponding to the human body image frame, the observed viewing angle direction d, the human body pose parameter θₜ, the average shape parameter β, and the latent code Lₜ into the initial model, and the output of the initial model may be the density σ(x) and the color c(x) corresponding to a camera point in the human body coordinate system. The above initial model may be expressed as F_{Φ}: (x, d, Lₜ, θₜ, β)→(σₜ(x), cₜ(x)), where Φ is a parameter of the network.

Step 405, determining the predicted image parameters of the pixels in the image plane corresponding to the human body image frame, based on the densities and the colors of the spatial points.

In the present embodiment, the executing body may use differentiable volume rendering to calculate RGB color values of each image plane. The principle of differentiable volume rendering is: Knowing a camera center, for a pixel position on the image plane, a ray r in the three-dimensional space may be determined; a pixel color value of the pixel may be obtained by integrating, by using an integral equation, the densities σ and the colors C of spatial points that the ray passes through.

In some alternative implementations of the present embodiment, the executing body may determine the predicted image parameters through: for each pixel in an image plane, determining a color of the each pixel based on densities and colors of spatial points through which a line connecting a camera position and the each pixel passes.

In this implementation, for each pixel in the image plane, the executing body may determine the color of the pixel based on the densities and the colors of the spatial points through which the line connecting the camera position and the pixel passes. In particular, the executing body may integrate the densities and colors of the spatial points through which the connecting line passes, and determine an integral value as the density and the color of the pixel.

In some alternative implementations of the present embodiment, the executing body may also sample a preset number of spatial points on the connecting line. It may be uniformly sampled when sampling. The preset number is represented by n, and {xₖ|k=1, . . . , n} represents each sampled point. Then, the executing body may determine the color of the pixel based on the densities and colors of the sampled spatial points. For each image plane, its predicted color value may be calculated through the following formula:

\tilde{C}ₜ(r)=Σₖ₌₁ⁿTₖ(1−exp(−σₜ(xₖ)δₖ))cₜ(xₖ),

Tₖ=exp(−Σⱼ₌₁^{k-1}σₜ(xⱼ)δⱼ);

δₖ=∥xₖ₊₁−xₖ∥.

here, \tilde{C}ₜ(r) represents, in the image plane corresponding to the t^{th} human body image frame, the predicted pixel value calculated based on the ray r. Tₖ is a cumulative throw ratio of the ray from a starting point to the k−1^{th} sampled point. σₜ(xₖ) represents the density value of each sampled point in the image plane corresponding to the t^{th} human body image frame. δₖ represents a distance between two adjacent sampled points. cₜ(xₖ) represents the pixel value of the sampled point in the image plane corresponding to the t^{th} human body image frame.

The method for training a model provided by the above embodiments of the present disclosure may implicitly models the shape, texture, and pose information of the human body through the neural radiance field, so that a rendered picture effect is more refined.

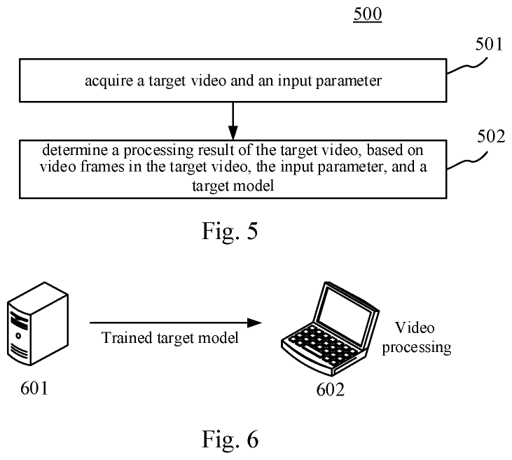

With further reference to FIG. 5, illustrating a flow 500 of a method for processing a video according to an embodiment of the present disclosure. As shown in FIG. 5, the method of the present embodiment may include the following steps:

Step 501, acquiring a target video and an input parameter.

In the present embodiment, the executing body may first acquire the target video and the input parameter. Here, the target video may be various videos of human body motions. The above input parameter may be a designated camera position, or a pose parameter of the human body.

Step 502, determining a processing result of the target video, based on video frames in the target video, the input parameter, and a target model.

In the present embodiment, the executing body may input the video frames in the target video and the input parameter into the target model, and the processing result of the target video may be obtained. Here, the target model may be obtained by training through the method for training a model described in the embodiments shown in FIG. 2 to FIG. 4. If the input parameter is the position of the camera, a new perspective of a human body image corresponding to the video frames in the target video may be obtained through the target model. If the input parameter is the pose parameter of the human body, a human body image corresponding to the video frames in the target video under a different action may be obtained through the target model.

According to the method for processing a video according to an embodiment of the present disclosure, it may directly render pictures of the human body under specified camera angles and poses, which enriches the diversity of video processing.

With further reference to FIG. 6, illustrating a schematic diagram of an application scenario of the method for training a model and the method for processing a video according to an embodiment of the present disclosure. In the application scenario of FIG. 6, a server 601 uses steps 201 to 204 to obtain a trained target model. Then, the above target model is sent to a terminal 602. The terminal 602 may use the above target model to perform video processing to obtain pictures of the human body under specified camera angles and poses.

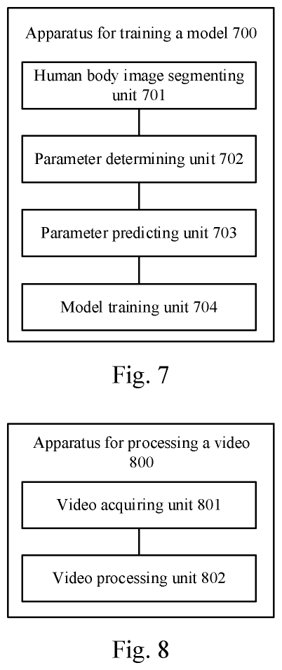

With further reference to FIG. 7, as an implementation of the method shown in the above figures, an embodiment of the present disclosure provides an apparatus for training a model. The embodiment of the apparatus corresponds to the embodiment of the method shown in FIG. 2, and the apparatus is particularly applicable to various electronic devices.

As shown in FIG. 7, the apparatus 700 for training a model of the present embodiment includes: a human body image segmenting unit 701, a parameter determining unit 702, a parameter predicting unit 703 and a model training unit 704.

The human body image segmenting unit 701 is configured to analyze a sample video, to determine a plurality of human body image frames in the sample video.

The parameter determining unit 702 is configured to determine human body-related parameters and camera-related parameters corresponding to each human body image frame.

The parameter predicting unit 703 is configured to determine, based on the human body-related parameters, the camera-related parameters and an initial model, predicted image parameters of an image plane corresponding to the each human body image frame, the initial model being used to represent a corresponding relationship between the human body-related parameters, the camera-related parameters and image parameters.

The model training unit 704 is configured to train the initial model based on original image parameters of the human body image frames in the sample video and the predicted image parameters of image planes corresponding to the human body image frames, to obtain a target model.

In some alternative implementations of the present embodiment, the parameter predicting unit 703 may be further configured to: for each human body image frame, determine a camera pose corresponding to the each human body image frame based on the human body-related parameters corresponding to the each human body image frame; and determine the predicted image parameters of the image plane corresponding to the each human body image frame, based on the camera pose, the human body-related parameter, the camera-related parameter, and the initial model.

In some alternative implementations of the present embodiment, the human body-related parameter includes a global rotation parameter and a global translation parameter of the human body. The parameter predicting unit 703 may be further configured to: convert the each human body image frame from a camera coordinate system to a human body coordinate system, based on the global rotation parameter and the global translation parameter corresponding to the each human body image frame; and determine the camera pose corresponding to the each human body image frame.

In some alternative implementations of the present embodiment, the parameter predicting unit 703 may be further configured to: determine, based on the initial model, latent codes corresponding to the each human body image frame; and input the camera pose, the human body-related parameters, the camera-related parameters, and the latent codes into the initial model, and determining the predicted image parameters of the image plane corresponding to the each human body image frame based on an output of the initial model.

In some alternative implementations of the present embodiment, the human body-related parameter includes a human body pose parameter and a human body shape parameter, and the predicted image parameters comprise densities and colors of pixels in the image plan. The parameter predicting unit 703 may be further configured to: determine spatial points in the human body coordinate system corresponding to pixels in the each human body image frame in the camera coordinate system, based on the global rotation parameter and the global translation parameter; determine viewing angle directions of the spatial points being observed by a camera in the human body coordinate system, based on the camera pose and coordinates of the spatial points in the human body coordinate system; determine an average shape parameter based on human body shape parameters corresponding to the human body image frames; for each human body image frame in the human body coordinate system, input the coordinates of the spatial points in the each human body image frame, the corresponding viewing angle directions, the human body pose parameter, the average shape parameter, and the latent codes into the initial model, to obtain densities and colors of the spatial points output by the initial model; and determine the predicted image parameters of the pixels in the image plane corresponding to the each human body image frame, based on the densities and the colors of the spatial points.

In some alternative implementations of the present embodiment, the parameter predicting unit 703 may be further configured to: for each pixel in the image plane, determine a color of the each pixel based on densities and colors of spatial points through which a line connecting a camera position and the each pixel passes.

In some alternative implementations of the present embodiment, the parameter predicting unit 703 may be further configured to: sample a preset number of spatial points on the connecting line; and determine the color of the pixel based on densities and colors of the sampled spatial points.

In some alternative implementations of the present embodiment, the model training unit 704 may be further configured to: determine a loss function based on the original image parameters and the predicted image parameters; and adjust, based on the loss function, parameters of the initial model to obtain the target model.

In some alternative implementations of the present embodiment, the model training unit 704 may be further configured to: adjust, based on the loss function, the latent codes corresponding to the human body image frames and the parameters of the initial model until the loss function converges, to obtain an intermediate model; and continue to adjust, based on the loss function, parameters of the intermediate model to obtain the target model.

It should be understood that the units 701 to 704 recorded in the apparatus 700 for training a model correspond to respective steps in the method described with reference to FIG. 2. Therefore, the operations and features described above with respect to the method for training a model are also applicable to the apparatus 700 and the units included therein, and detailed description thereof will be omitted.

With further reference to FIG. 8, as an implementation of the method shown in the above FIG. 5, an embodiment of the present disclosure provides an apparatus for processing a video. The embodiment of the apparatus corresponds to the embodiment of the method shown in FIG. 5, and the apparatus is particularly applicable to various electronic devices.

As shown in FIG. 8, the apparatus 800 for processing a video of the present embodiment includes: a video acquiring unit 801, and a video processing unit 802.

The video acquiring unit 801 is configured to acquire a target video and an input parameter.

The video processing unit 802 is configured to determine a processing result of the target video, based on video frames in the target video, the input parameter, and the target model obtained by training through the method for training a model described by any embodiment of FIG. 2 to FIG. 4.

It should be understood that the units 801 to 802 recorded in the apparatus 800 for processing a video correspond to respective steps in the method described with reference to FIG. 5. Therefore, the operations and features described above with respect to the method for processing a video are also applicable to the apparatus 800 and the units included therein, and detailed description thereof will be omitted.

In the technical solution of the present disclosure, the acquisition, storage and application of the user personal information are all in accordance with the provisions of the relevant laws and regulations, and the public order and good customs are not violated.

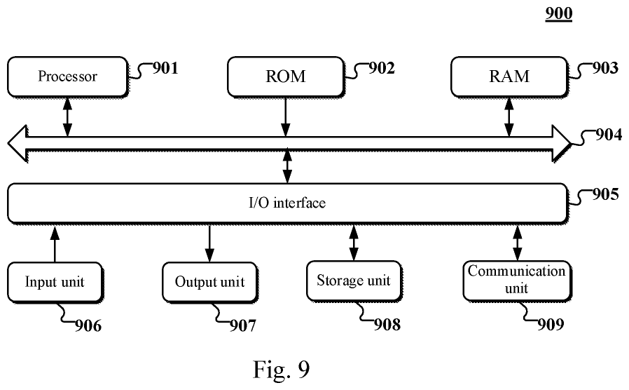

FIG. 9 illustrates a block diagram of an electronic device 900 for implementing the method for training a model and the method for processing a video according to embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 9, the electronic device 900 includes a processor 901, which may perform various appropriate actions and processing, based on a computer program stored in a read-only memory (ROM) 902 or a computer program loaded from a storage unit 908 into a random access memory (RAM) 903. In the RAM 903, various programs and data required for the operation of the electronic device 900 may also be stored. The processor 901, the ROM 902, and the RAM 903 are connected to each other through a bus 904. An input/output (I/O) interface 905 is also connected to the bus 904.

A plurality of parts in the electronic device 900 are connected to the I/O interface 905, including: an input unit 906, for example, a keyboard and a mouse; an output unit 907, for example, various types of displays and speakers; the storage unit 908, for example, a disk and an optical disk; and a communication unit 909, for example, a network card, a modem, or a wireless communication transceiver. The communication unit 909 allows the electronic device 900 to exchange information/data with other devices over a computer network such as the Internet and/or various telecommunication networks.

The processor 901 may be various general-purpose and/or dedicated processing components having processing and computing capabilities. Some examples of the processor 901 include, but are not limited to, central processing unit (CPU), graphics processing unit (GPU), various dedicated artificial intelligence (AI) computing chips, various processors running machine learning model algorithms, digital signal processors (DSP), and any appropriate processors, controllers, microcontrollers, etc. The processor 901 performs the various methods and processes described above, such as the method for training a model, the method for processing a video. For example, in some embodiments, the method for training a model, the method for processing a video may be implemented as a computer software program, which is tangibly included in a machine readable storage medium, such as the storage unit 908. In some embodiments, part or all of the computer program may be loaded and/or installed on the electronic device 900 via the ROM 902 and/or the communication unit 909. When the computer program is loaded into the RAM 903 and executed by the processor 901, one or more steps of the method for training a model, the method for processing a video described above may be performed. Alternatively, in other embodiments, the processor 901 may be configured to perform the method for training a model, the method for processing a video by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), complex programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in any combination of one or more programming languages. The above program codes may be encapsulated into computer program products. These program codes or computer program products may be provided to a processor or controller of a general purpose computer, special purpose computer or other programmable data processing apparatus such that the program codes, when executed by the processor 901, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer. Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), and Internet.

The computer system may include a client and a server. The client and the server are generally far from each other and usually interact through a communication network. The client and server relationship is generated by computer programs operating on the corresponding computer and having client-server relationship with each other. The server may be a cloud server, also known as a cloud computing server or a cloud host, which is a host product in a cloud computing service system and may solve the defects of difficult management and weak service scalability existing in a conventional physical host and a VPS (Virtual Private Server) service.

It should be understood that various forms of processes shown above may be used to reorder, add, or delete steps. For example, the steps described in embodiments of the present disclosure may be performed in parallel, sequentially, or in different orders, as long as the desired results of the technical solution disclosed in embodiments of the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for training a model, the method comprising:
analyzing a sample video, to determine a plurality of human body image frames in the sample video;
determining human body-related parameters and camera-related parameters corresponding to each human body image frame;
determining, based on the human body-related parameters, the camera-related parameters and an initial model, predicted image parameters of an image plane corresponding to the each human body image frame, the initial model being used to represent a corresponding relationship between the human body-related parameters, the camera-related parameters and image parameters; and
training the initial model based on original image parameters of the human body image frames in the sample video and the predicted image parameters of image planes corresponding to the human body image frames, to obtain a target model.

2. The method according to claim 1, wherein the determining, based on the human body-related parameters, the camera-related parameters and an initial model, the predicted image parameters of the image plane corresponding to the each human body image frame, comprises:
for each human body image frame, determining a camera pose corresponding to the each human body image frame based on the human body-related parameters corresponding to the each human body image frame; and
determining the predicted image parameters of the image plane corresponding to the each human body image frame, based on the camera pose, the human body-related parameter, the camera-related parameter, and the initial model.

3. The method according to claim 2, wherein the human body-related parameters comprise a global rotation parameter and a global translation parameter of a human body; and
the determining the camera pose corresponding to the each human body image frame based on the human body-related parameters corresponding to the each human body image frame, comprises:
converting the each human body image frame from a camera coordinate system to a human body coordinate system, based on the global rotation parameter and the global translation parameter corresponding to the each human body image frame; and
determining the camera pose corresponding to the each human body image frame.

4. The method according to claim 2, wherein the determining the predicted image parameters of the image plane corresponding to the each human body image frame, based on the camera pose, the human body-related parameters, the camera-related parameters, and the initial model, comprises:
determining, based on the initial model, latent codes corresponding to the each human body image frame; and
inputting the camera pose, the human body-related parameters, the camera-related parameters, and the latent codes into the initial model, and determining the predicted image parameters of the image plane corresponding to the each human body image frame based on an output of the initial model.

5. The method according to claim 4, wherein the human body-related parameters comprise a human body pose parameter and a human body shape parameter, and the predicted image parameters comprise densities and colors of pixels in the image plane; and
the inputting the camera pose, the human body-related parameters, the camera-related parameters, and the latent codes into the initial model, and determining the predicted image parameters of the image plane corresponding to the each human body image frame based on an output of the initial model, comprises:
determining spatial points in the human body coordinate system corresponding to pixels in the each human body image frame in the camera coordinate system, based on the global rotation parameter and the global translation parameter;
determining viewing angle directions of the spatial points being observed by a camera in the human body coordinate system, based on the camera pose and coordinates of the spatial points in the human body coordinate system;
determining an average shape parameter based on human body shape parameters corresponding to the human body image frames;
for each human body image frame in the human body coordinate system, inputting the coordinates of the spatial points in the each human body image frame, the corresponding viewing angle directions, the human body pose parameter, the average shape parameter, and the latent codes into the initial model, to obtain densities and colors of the spatial points output by the initial model; and
determining the predicted image parameters of the pixels in the image plane corresponding to the each human body image frame, based on the densities and the colors of the spatial points.

6. The method according to claim 5, wherein the determining the predicted image parameters of the pixels in the image plane corresponding to the each human body image frame, based on the densities and the colors of the spatial points, comprises:
for each pixel in the image plane, determining a color of the each pixel based on densities and colors of spatial points through which a line connecting a camera position and the each pixel passes.

7. The method according to claim 6, wherein the determining the color of the each pixel based on the densities and the colors of the spatial points through which the line connecting the camera position and the each pixel passes, comprises:
sampling a preset number of spatial points on the connecting line; and
determining the color of the pixel based on densities and colors of the sampled spatial points.

8. The method according to claim 1, wherein the training the initial model based on the original image parameters of the human body image frames in the sample video and the predicted image parameters, to obtain the target model, comprises:
determining a loss function based on the original image parameters and the predicted image parameters; and
adjusting, based on the loss function, parameters of the initial model to obtain the target model.

9. The method according to claim 8, wherein the adjusting, based on the loss function, the parameters of the initial model to obtain the target model, comprises:
adjusting, based on the loss function, the latent codes corresponding to the human body image frames and the parameters of the initial model until the loss function converges, to obtain an intermediate model; and
continuing to adjust, based on the loss function, parameters of the intermediate model to obtain the target model.

10. A method for processing a video, the method comprising:
acquiring a target video and an input parameter; and
determining a processing result of the target video, based on video frames in the target video, the input parameter, and the target model trained and obtained by the method according to claim 1.

11. An electronic device, comprising:
at least one processor; and
a memory communicatively connected to the at least one processor; wherein,
the memory stores instructions executable by the at least one processor, and the instructions, when executed by the at least one processor, cause the at least one processor to perform operations, the operations comprising:
analyzing a sample video, to determine a plurality of human body image frames in the sample video;
determining human body-related parameters and camera-related parameters corresponding to each human body image frame;
determining, based on the human body-related parameters, the camera-related parameters and an initial model, predicted image parameters of an image plane corresponding to the each human body image frame, the initial model being used to represent a corresponding relationship between the human body-related parameters, the camera-related parameters and image parameters; and
training the initial model based on original image parameters of the human body image frames in the sample video and the predicted image parameters of image planes corresponding to the human body image frames, to obtain a target model.

12. The electronic device according to claim 11, wherein the determining, based on the human body-related parameters, the camera-related parameters and an initial model, the predicted image parameters of the image plane corresponding to the each human body image frame, comprises:
for each human body image frame, determining a camera pose corresponding to the each human body image frame based on the human body-related parameters corresponding to the each human body image frame; and
determining the predicted image parameters of the image plane corresponding to the each human body image frame, based on the camera pose, the human body-related parameter, the camera-related parameter, and the initial model.

13. The electronic device according to claim 12, wherein the human body-related parameters comprise a global rotation parameter and a global translation parameter of a human body; and
the determining the camera pose corresponding to the each human body image frame based on the human body-related parameters corresponding to the each human body image frame, comprises:
converting the each human body image frame from a camera coordinate system to a human body coordinate system, based on the global rotation parameter and the global translation parameter corresponding to the each human body image frame; and
determining the camera pose corresponding to the each human body image frame.

14. The electronic device according to claim 12, wherein the determining the predicted image parameters of the image plane corresponding to the each human body image frame, based on the camera pose, the human body-related parameters, the camera-related parameters, and the initial model, comprises:
determining, based on the initial model, latent codes corresponding to the each human body image frame; and
inputting the camera pose, the human body-related parameters, the camera-related parameters, and the latent codes into the initial model, and determining the predicted image parameters of the image plane corresponding to the each human body image frame based on an output of the initial model.

15. The electronic device according to claim 14, wherein the human body-related parameters comprise a human body pose parameter and a human body shape parameter, and the predicted image parameters comprise densities and colors of pixels in the image plane; and
the inputting the camera pose, the human body-related parameters, the camera-related parameters, and the latent codes into the initial model, and determining the predicted image parameters of the image plane corresponding to the each human body image frame based on an output of the initial model, comprises:
determining spatial points in the human body coordinate system corresponding to pixels in the each human body image frame in the camera coordinate system, based on the global rotation parameter and the global translation parameter;
determining viewing angle directions of the spatial points being observed by a camera in the human body coordinate system, based on the camera pose and coordinates of the spatial points in the human body coordinate system;
determining an average shape parameter based on human body shape parameters corresponding to the human body image frames;
for each human body image frame in the human body coordinate system, inputting the coordinates of the spatial points in the each human body image frame, the corresponding viewing angle directions, the human body pose parameter, the average shape parameter, and the latent codes into the initial model, to obtain densities and colors of the spatial points output by the initial model; and
determining the predicted image parameters of the pixels in the image plane corresponding to the each human body image frame, based on the densities and the colors of the spatial points.

16. The electronic device according to claim 15, wherein the determining the predicted image parameters of the pixels in the image plane corresponding to the each human body image frame, based on the densities and the colors of the spatial points, comprises:
for each pixel in the image plane, determining a color of the each pixel based on densities and colors of spatial points through which a line connecting a camera position and the each pixel passes.

17. The electronic device according to claim 16, wherein the determining the color of the each pixel based on the densities and the colors of the spatial points through which the line connecting the camera position and the each pixel passes, comprises:
sampling a preset number of spatial points on the connecting line; and
determining the color of the pixel based on densities and colors of the sampled spatial points.

18. The electronic device according to claim 11, wherein the training the initial model based on the original image parameters of the human body image frames in the sample video and the predicted image parameters, to obtain the target model, comprises:
determining a loss function based on the original image parameters and the predicted image parameters; and
adjusting, based on the loss function, parameters of the initial model to obtain the target model.

19. The electronic device according to claim 18, wherein the adjusting, based on the loss function, the parameters of the initial model to obtain the target model, comprises:
adjusting, based on the loss function, the latent codes corresponding to the human body image frames and the parameters of the initial model until the loss function converges, to obtain an intermediate model; and
continuing to adjust, based on the loss function, parameters of the intermediate model to obtain the target model.

20. A non-transitory computer readable storage medium storing computer instructions, wherein, the computer instructions, when executed by a computer, cause the computer to perform operations, the operations comprising:
analyzing a sample video, to determine a plurality of human body image frames in the sample video;
determining human body-related parameters and camera-related parameters corresponding to each human body image frame;
determining, based on the human body-related parameters, the camera-related parameters and an initial model, predicted image parameters of an image plane corresponding to the each human body image frame, the initial model being used to represent a corresponding relationship between the human body-related parameters, the camera-related parameters and image parameters; and
training the initial model based on original image parameters of the human body image frames in the sample video and the predicted image parameters of image planes corresponding to the human body image frames, to obtain a target model.
